(19) United States
(12) Patent Application Publication
(10) Pub. No.: US 2015/0129244 A1
(43) Pub. Date: May 14, 2015

(54) SYSTEM AND METHODS FOR DELIVERY OF MATERIALS

(71) Applicant: Cornell Center for Technology, Enterprise & Commercialization, Ithaca, NY (US)

(72) Inventors: Hod Lipson, Ithaca, NY (US); Aviv Blumfield, Scarsdale, NY (US)

(21) Appl. No.: 14/381,379

(22) PCT Filed: Mar. 1, 2013
(86) PCT No.: PCT/US13/28592

§ 371 Date: Aug. 27, 2014

Related U.S. Application Data
(60) Provisional application No. 61/605,629, filed on Mar. 1, 2012.

(51) Int. Cl. A62C 35/68

(52) U.S. Cl. CPC A62C 35/68
USPC 169/16

(57) ABSTRACT

A system and methods for delivering materials including a device with a central manifold portion comprising an intake and one or more outlets through which the quantity of and the pressure and direction at which material is delivered may be controlled. Devices according to the invention control delivery of materials by achieving one or more properties such as flight elevation, flight stabilization, flight maneuvering, environmental resiliency, and ejection of material such as water.

### CROSS-REFERENCE TO RELATED APPLICATIONS

The present application claims priority to U.S. Provisional Patent Application No. 61/605,629 filed Mar. 1, 2012, the disclosure of which is hereby incorporated by reference in its entirety.

### FIELD OF THE INVENTION

The present invention relates generally to a system and methods for delivering materials. More specifically, the present invention relates to a system and methods by which the quantity of and the pressure and direction at which material is delivered may be controlled. Preferred embodiments of the present invention facilitate the delivery of materials to be remotely or autonomously controlled. Advantageously, certain embodiments of the present invention permit a material such as a foam or a liquid to be delivered in order to cool an area (such as in a damaged nuclear power facility), extinguish a fire, or to eradicate, neutralize, or dilute a hazardous material.

### BACKGROUND OF THE INVENTION

Fires, floods, hurricanes, and nuclear meltdowns are examples of frequently occurring natural and human made disasters. The environments created by these disasters prove to be detrimental for humans. Current methods to combat the disasters include delivery of materials by human operated machinery which puts the operators at risk.

Many systems and methods are known by which materials can be manually delivered to achieve various objectives. For example, fire fighters have various apparatuses by which they can direct fire-fighting foam or water to extinguish a fire. Nuclear accidents can be remediated in part through the intervention of workers directing material, water, or a liquid that includes other materials or organisms to the accident site. Personnel can clean surfaces such as windows on a high rise building by manually applying and removing water and a cleaning agent from the surfaces. Many such events or states, however, create great risks for those controlling the delivery of the materials. As a specific example, the existing fire control methods for marine vessels are inefficient when major fires occur in the ship interior when the vessel is out at sea.

An effective method to control fires at sea may be to use an autonomous aerial robot, which uses seawater to propel the apparatus and simultaneously extinguish the fire.

With the evolution of robotics, using a coordinated assembly of robots to combat a disaster is becoming feasible. A group of robots can detect and control a disaster using an algorithm called S+T, which solves the multi-robot task allocation (MRTA) problem by facilitating cooperation among the group of robots to accomplish certain tasks. If one robot cannot execute a task by itself, it asks for help and, if possible, another robot provides the required service. Robots with different capabilities distributed in an environment can be orchestrated to operate in unison to respond to a disaster in the most efficient way via the algorithm.

In the case of some fires, an aerial robot would prove beneficial to reach locations that would prove dangerous or inefficient to access by existing ground based fire-fighting technologies. Aerial robots, however, must perform autonomously on some level to sustain flight.

A demand exists for a system and methods directed to autonomous aerial devices by which the quantity of and the pressure and direction at which material is delivered may be controlled including in hazardous or otherwise difficult situations thereby reducing risk, for example, to human health. The present invention satisfies the demand.

### SUMMARY OF THE INVENTION

Disclosed are system and methods for controlled delivery of materials. In certain embodiments, the system comprises a device that includes at least one intake through which a material is received and one or more outlets through which the material may be delivered. The intake is adapted for attachment, optionally, reversible attachment, to a conduit through which the material may be delivered over a distance. One such conduit is a hose. In some embodiments, the intake is operably connected to a manifold that in turn directs flow of the material to one or more outlets, one or more of which optionally defines, or is fitted with, a nozzle. Nozzles may be used to increase the pressure at which material is delivered.

Automatic control of the motion of the device for delivery of materials may be achieved by the automatic redirection of material outlets through one or more of the nozzles. The flow reaction forces applied by the material outlets allow the device to lift and maneuver.

The system may be controlled autonomously by an on-board computer that, along with the flow of material into, through, and out the device, lifts and maneuvers the device. The system may be remotely controlled by an operator and/or a computer, for example, a computer attached—either wired or wirelessly—to the device that communicates with the on-board computer. The device may also include an off-board computer. Instead of being located on the device, the off-board computer is located anywhere remotely from the device such as integrated with a base station that communicates with the device.

The device may be equipped with and/or used in conjunction with one or more components such as an accelerometer, a magnetometer, a global positioning system (GPS), a camera, a sensor, a gyroscope, or other inertial navigational systems. The components are used to collect information regarding the state in which the device is operating as well as facilitate the operation of the device and delivery of the material.

Sensors can be used to detect temperature such as to identify human beings in an environment or to independently identify an open flame. Optionally, control of the device may be achieved by using a motion sensing input device such as a Kinect sensor. A Kinect sensor includes a combination of a special microchip, color camera and a depth camera or infrared projector to track the movement of the device in three dimension to allow for completely hands-free control of the device. The Kinect sensor is programmed to detect colors and their respective depth data. Multiple colors are used—one for each output, each input, and one on the center or other specified locations on the device. The depth data of each color is used to calculate the 3D position and 3D orientation of the device. Using the 3D position and 3D orientation, material output can be manipulated to stabilize the device.

Material output can be manipulated to stabilize the device using one or more valves, actuators, and weights. The use of valves, linear actuators, and/or moveable weights may be configured to control the flow of material through one or more of the outlets and thereby control or stabilize the device.

According to the invention, devices for controlled delivery of materials achieve one or more properties such as flight elevation, flight stabilization, flight maneuvering, environmental resiliency, and ejection of material (e.g., water for fire extinguishing).

The device can be manufactured from any durable material including those materials that can withstand extreme temperatures, for example, fire resistant to resist burning. Materials may also include those that are water resistant to resist damage. It is contemplated that the device may be manufactured from one or more materials including for example, any metal such as steel or aluminum or any plastic such as silicone, polyurethane, polypropylene, polyvinyl chloride, as well as materials such as perlite or gypsum.

The system and methods according to the invention can be used in a variety of applications to provide many advantages.

In one embodiment, the disclosed system and methods may be implanted in emergency response applications such as to extinguish fires by permitting delivery of material, e.g., water or foam, nearer the fire and into areas that are otherwise unreachable. When connected to a source of materials useful to cool an area or extinguish a fire, the device can be used to reduce dangerously high temperature levels or to extinguish fires, particularly in situations in which manual manipulation of a hose can be risky, difficult, or inefficient.

Further, advantageously, the system and methods can be used in transportation applications. For example, the device can be used to carry or transport materials or people as well as deliver materials in spaces or conditions in which a human could not fit or safely exist.

An additional advantage of the present invention is that embodiments may be used in maintenance and surveillance applications, for example, to inspect and/or monitor pipes in addition to applying materials for repair if needed.

In another embodiment, the invention may be used in irrigation applications including the delivery of fluid materials to large or complex areas in which simple sprinklers are inefficient or unavailable. The system and methods can be used in aerial irrigation including, for example, delivery of liquids for irrigation including fertilizers and pesticides, and for other in which materials such as fluid materials, must be applied.

Another application may relate to cleaning, e.g., to clean hazardous materials or tall buildings, so as to minimize risk of injury or harm to the operator. Pipes may be cleaned internally by maneuvering the devices through the pipes.

In still another embodiment, the systems may be used in mining, e.g., to deliver water to a mining site, or to inspect mining sites, e.g., using a camera or other sensor.

Advantageously, the system and methods may be used in search and rescue applications. The device may be relatively thin and narrow to allow maneuvering of the device through tight spaces. In addition, the device may have a camera or other sensor such that it can be flown into tight areas, for example, a building wreck, to search for people or animals.

In another embodiment, the system and methods may be used in entertainment applications such as a toy or game. For example, a remote control can be used to open and close certain valves at the outputs, adjust moveable weights, and activate an actuator to stabilize and maneuver the device. As another example, the toy may be controlled using a smartphone where the smartphone could be used to detect the orientation and to pilot the device. Multiple similarly controlled devices with multiple operators could be used in a game in which the devices interact or engage, e.g., operators could attempt to interrupt the flight of other devices. In another version, a low priced toy may be made in which the device is piloted by modulating the water flow from a hose and/or twisting the hose.

In addition, the system and methods may also be used in recreational applications such as at swimming pools and water parks.

It is also contemplated that multiple devices may be attached to a conduit and that each device may be controlled in a coordinated way. Optionally, a pump can be inserted in line with the material supply to increase the pressure and/or flow rate into the device.

Advantageously, embodiments of the system of the present invention may be used in conjunction with other remotely or autonomously controlled devices in a system of delivering fluids.

The described embodiments are to be considered in all respects only as illustrative and not restrictive, and the scope of the invention is not limited to the foregoing description. Those of skill in the art will recognize changes, substitutions and other modifications that will nonetheless come within the scope of the invention and range of the claims.

### DESCRIPTION OF THE DRAWINGS

The preferred embodiments of the invention will be described in conjunction with the appended drawing provided to illustrate and not to the limit the invention, where like designations denote like elements, and in which:

FIG. 1 illustrates a device according to one embodiment of the invention.

FIG. 2 illustrates a device according to another embodiment of the invention.

FIG. 3 illustrates a device according to yet another embodiment of the invention.

FIG. 4 is a block diagram to describe the configuration of an on-board computer according to an embodiment of the invention.

FIG. 5 is a table illustrating lift force according to the invention.

FIG. 6 is a table illustrating results of water flow, pressure, and flight elevation according to one embodiment of the invention.

### DETAILED DESCRIPTION OF THE PREFERRED EMBODIMENT

Although a number of embodiments of the invention will be described in the following, it is understood that these embodiments are presented by way of example only, not limitation. The detailed description of the exemplary embodiments of the invention should not be construed to limit the scope or breadth of the invention.

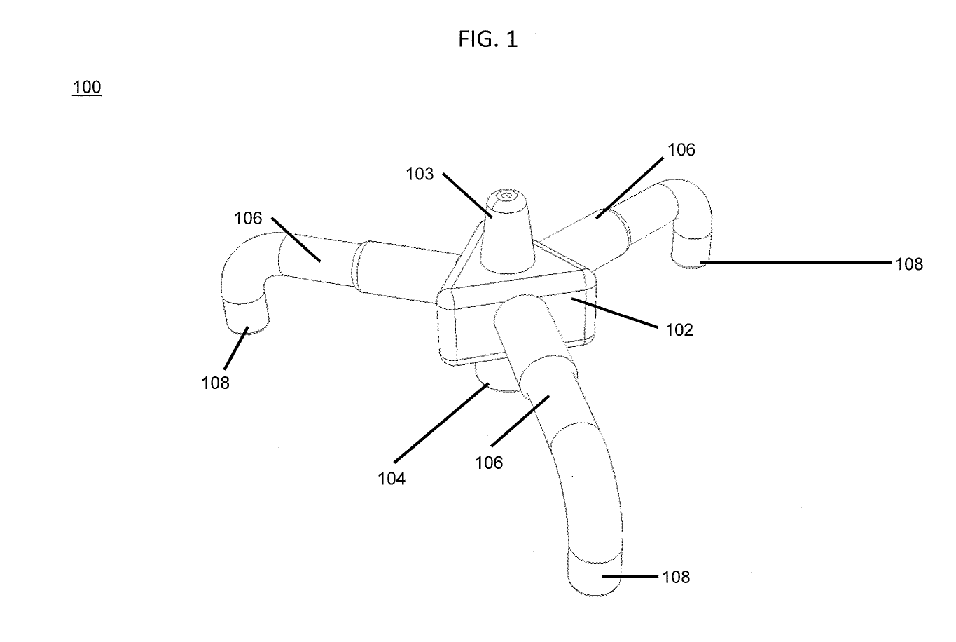

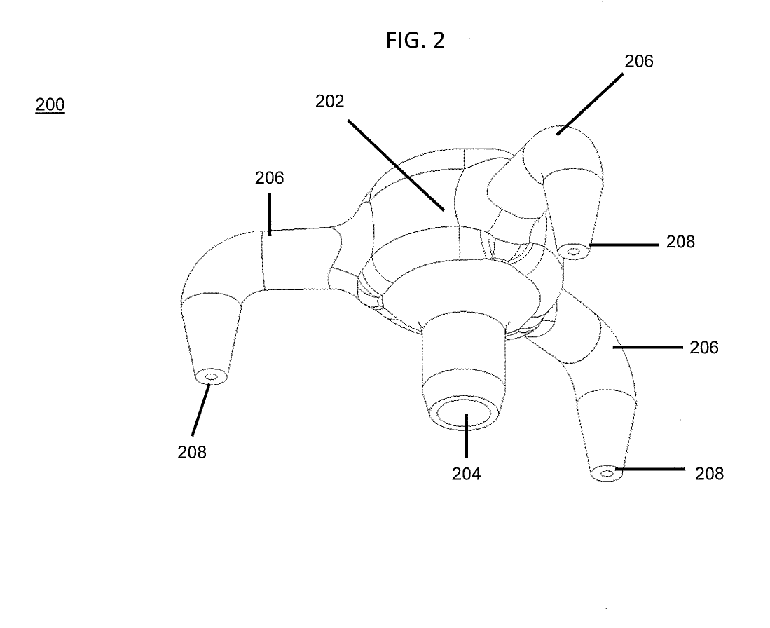

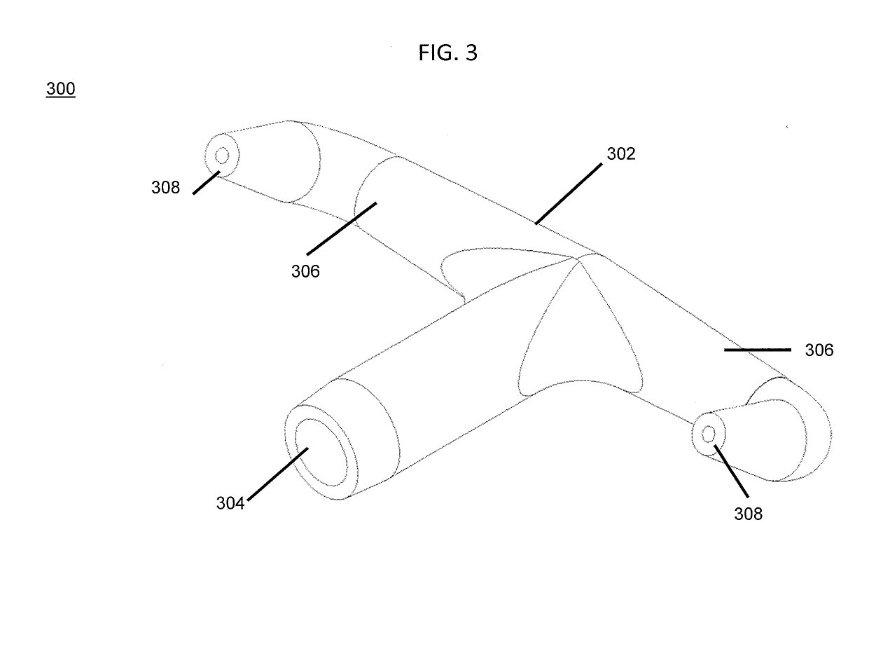

FIG. 1, FIG. 2, and FIG. 3 illustrate different embodiments of the device according to the invention. As shown in FIG. 1, device 100 includes a central manifold portion 102 comprising an intake 104 and one or more outlets 106. The central manifold portion 102 comprises a housing portion 103. The housing portion 103 can be used to protect an on-board computer. Each outlet 106 defines or is fitted with a nozzle 108. As shown in FIG. 2, device 200 includes a central manifold portion 202 comprising an intake 204 and one or more outlets 206. Each outlet 206 defines or is fitted with a nozzle 208. FIG. 3 illustrates another embodiment of the device 300 with a central manifold portion 302 comprising an intake 304 and one or more outlets 306. Each outlet 306 defines or is fitted with a nozzle 308.

Any of the devices 100, 200, 300 may further comprise one or more valves, actuators, and weights (not shown) that may be manipulated to control the flow of material through the one or more outlets 106, 206, 306 thereby controlling and stabilizing the device. The valves, actuators, and weights may be positioned within the central manifold portion 102, 202, 302 or anywhere within the outlet 106, 206, 306 and may further be positioned at the nozzle 108, 208, 308.

According to FIG. 1, a conduit is attached to the intake 104 of the device 100. In one embodiment, the conduit is a hose such as a garden hose or fire hose. The intake 104 may include a mounting element to facilitate attachment of the hose to the device 100. The device 100 redirects the flow of material through a central manifold portion 102 into three outlets 106 and out from three nozzles 108. In this embodiment, the nozzles 108 are pointed parallel to one another as well as parallel to the intake 104 such that the flow of material from the nozzles 108 is parallel to the flow of material into the intake 104.

According to FIG. 2, a conduit is attached to the intake 204 of the device 200. Once material is provided to the device 200 through the intake 204, the device 200 redirects the flow of material through a central manifold portion 202 into three outlets 206 and out from three nozzles 208. In this embodiment, the nozzles 208 are pointed slightly away from one another as well as antiparallel to the intake 204 such that the flow of material from the nozzles 208 is antiparallel to the flow of material into the intake 204.

FIG. 3 illustrates a device 300 that redirects the flow of material through a central manifold portion 302 into two outlets 206 and out from two nozzles 208. In this embodiment, the nozzles 208 are pointed parallel to one another, but antiparallel to the intake 304 such that the flow of material from the nozzles 308 is antiparallel to the flow of material into the intake 304.

Although the devices have been described with a particular number of outlets and nozzles, it is contemplated that a device according to the invention may be constructed with any number of outlets and nozzles as well as the outlets having additional degrees of freedom to achieve greater control.

Although the embodiments according to FIG. 1, FIG. 2, and FIG. 3 have been described with respect to material flowing into the intake 104, 204, 304 and out through nozzles 108, 208, 308, it is also contemplated that material can flow into the nozzles 108, 208, 308 and out through the intake 104, 204, 304.

The distribution of the flow of material from the device 100, 200, 300 can provide autonomous control through both the total thrust force as well as the tilt angle of the central manifold 102, 202, 302. Essentially, material delivered into, through, and out the nozzles controls pitch, roll and lift of the device 100, 200, 300. In addition, the nozzles may allow spraying material in other directions for purposes other than providing thrust. Dynamic modulation of the flow can provide further control, such as stabilization, spinning, wiggling, ratcheting, scrubbing, or vibrating.

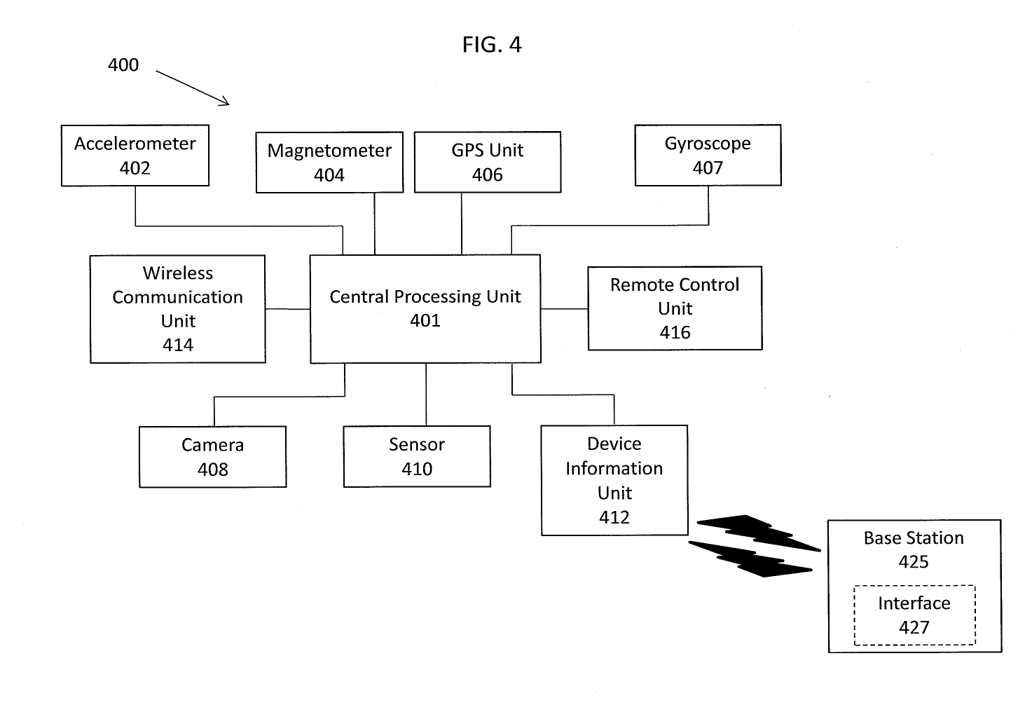

In embodiments in which the device is autonomously or remotely controlled, the device may include an on-board computer 400 as discussed in reference to FIG. 4. FIG. 4 is a block diagram to describe the configuration of the on-board computer 400 of which a portion may be located anywhere within the device such as the central manifold portion. In one embodiment, the on-board computer 400 may be located in a housing portion of the central manifold portion (see FIG. 1). The housing portion may be a protective and water-tight housing to protect any sensitive equipment on board the device. The device may also communicate with an off-board computer that may be located anywhere remotely from the device such as integrated with a base station that communicates with the device.

The on-board computer 400 according to the embodiment may communicate with a ground system made up of a base station 425 including interface 427 that performs operation control of the device based on commands transmitted from the base station 425 to the central processing unit 401.

The interface 427 facilitates control of flight in which the device is autonomously or remotely instructed. The interface 427 also may communicate information about the device by receiving information from the device, specifically the central processing unit (CPU) 401, which may be connected to one or more integrated components. It is contemplated that the interface 427 may be a graphical user interface or touch screen on any type of computing device such as a mobile device, handheld device, desktop device, or tablet-type device.

The CPU 401 may be connected to and communicate with one or more integrated components. The components may be of any type that allows the device to stabilize and/or maneuver. One component may include an accelerometer 402 to measure acceleration of the device. The accelerometer 402 may measure acceleration in terms of magnitude and direction, and can be used to sense orientation, vibration, shock and when the device is falling.

Another component connected to and communicating with the CPU 401 may include a magnetometer 404. The magnetometer 404 measures the strength and, in some cases, the direction of magnetic fields. A magnetometer 404 can measure a particular direction of a magnetic field relative to the spatial orientation of the device, similar to that of a compass.

A global positioning system (GPS) unit 406 measures position, altitude, etc., of the device.

The CPU may also be connected to or communicate with a gyroscope 407. The gyroscope 407 can measure or maintain orientation, based on the principles of angular momentum.

A camera 408 may be used to capture images that can be communicated to the CPU 401 for transmission back to the interface 427 of the base station 425. These images may be still photographs or moving images such as videos or movies. The images may be used by the CPU 401 to perform what is known as “machine vision”, which uses mathematical analysis of visual data to recognize the essential properties that apply to the current mission such as, identifying the location of a fire in a landscape based on color.

Sensors 410 can be used for a variety of purposes. A sensor can be used to detect and measure temperature of the device and/or a sensor can be used to measure attitude angle and angular airspeed.

The device information unit 412 includes information directed to the device such as number of nozzles, number of valves, angle between adjacent nozzles, and direction of nozzles from one another (e.g., opposing, parallel). This information may be valuable in controlling the device in terms of how many nozzles are active, how many valves are open and direction of material flow (e.g., in through intake or out through intake).

Information from each of the components—images from the camera, position from the GPS unit 406, acceleration from the accelerometer 402—can be communicated to the CPU 401 that further communicates the information to the base station 425 such that it can be displayed on the interface 427. The information can be transmitted wirelessly utilizing the wireless communication unit 414.

The remote control unit 416 receives a command such as a “move right” command, etc., from the base station 425 through a reception antenna. The command is communicated from the remote control unit 416 to the CPU 401 which then makes adjustments such as to the number of active nozzles, the direction of active nozzles, and the number of open/closed valves to achieve the movement as specified by the command.

The command transmitted from the base station 425 is transmitted through the reception antenna to the remote control unit, which then accomplishes predetermined flight control based on the command, thereby making it possible to remotely control the device.

Again, the CPU 401 can include one or more of the above described components depending on the application for which the device is used. For example, camera may be used 408 in search and rescue applications or irrigation applications.

As mentioned above, the device may also communicate with an off-board computer that may be located anywhere remotely from the device such as integrated with a base station that communicates with the device. An off-board sensor such as a Kinect sensor can be used to detect the depth data of a color, which can be used to calculate 3D position and 3D orientation. As an example, a Kinect sensor could be used to detect colors and their respective depth data. Multiple colors are used—one for each output, each input, and one on the center or other specified locations on the device. The depth data of each color is used to calculate the 3D position and 3D orientation of the device in order to manipulate the material output to stabilize the device.

A unique feature of the device is that no motor is required to maneuver the device; material dispensed from the nozzles of the device assists with maneuverability. For example, a liquid such as water is pumped into the robot and released in a controlled yet high pressurized manner from multiple outputs or nozzles thereby propelling the device. The upward thrust produced can be used for moving up and down such that the device achieves lift at different set points of water. In addition, the automatic control of the motion of the device for delivery of materials may be achieved by the automatic redirection of material outlets through one or more of the nozzles.

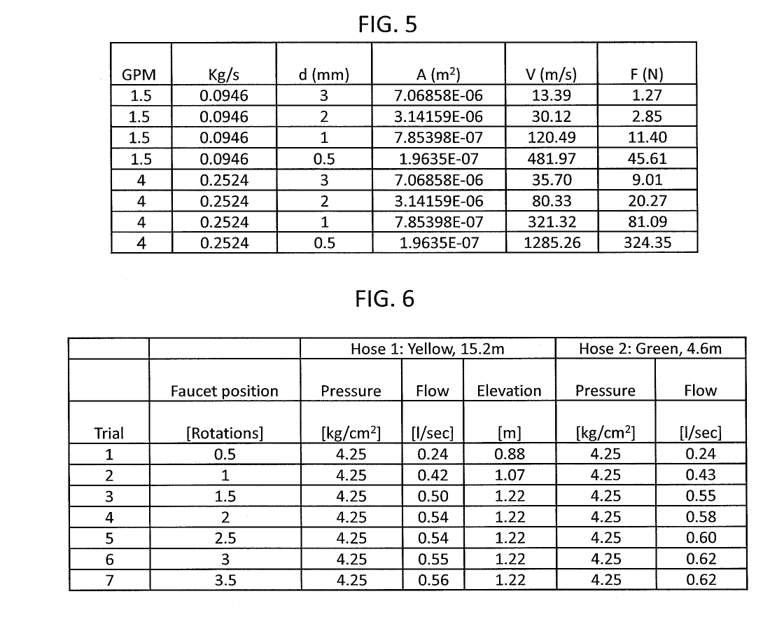

FIG. 5 is a table illustrating lift force according to the invention. The table illustrates number of gallons per minute (GPM), flow rate (Kg/s), diameter (mm) and cross-sectional area (m²) of the outlets, velocity (m/s) of fluid through the device, and lift force (N). As can be seen in FIG. 5, lift force can be controlled by varying, for example, the flow rate into the device, and the diameter or cross-sectional area of the outlets.

In one embodiment, two hoses of different lengths (15.2 m and 4.6 m) were tested for pressure, water flow and elevation of the device. The pressure of both hoses was the same and the flow difference was within 10%. Although the 4.6m hose provided a stronger flow, the 15.2 m hose was chosen to test the flight elevation for its maneuverability.

As can be seen in FIG. 6, the flight elevation increased with increasing rotations of the water faucet. The elevation leveled out at 1.22 m after 1.5 rotations, which would provide a flow of 0.5 L/sec when the apparatus was disconnected from the hose (0% resistance).

While the invention has been described with reference to particular embodiments, those skilled in the art will recognize that many changes may be made thereto without departing from the scope of the invention. Each of these embodiments and variants thereof is contemplated as falling with the scope of the claimed invention, as set forth in the following claims.

1. A system for delivery of material, the system comprising a device comprising a central manifold portion comprising an intake and one or more outlets, the intake adapted for attachment to a hose, the intake operably connected to the one or more outlets, such that material introduced from the hose into the intake flows out of the central manifold portion through the one or more outlets, wherein each outlet defines a nozzle, and wherein the material output from the one or more nozzles lifts the device.

2. The system of claim 1 wherein the device further comprises one or more valves, each valve configured to allow control of the flow of liquid through the one or more outlets.

3. The system of claim 1 further comprising a hose attached to the intake of the central manifold portion.

4. The system of claim 3 wherein the nozzles are configured such that flow of a liquid out of the nozzles is antiparallel to the flow of the liquid into the intake.

5. The system of claim 1 wherein movement of the device is remotely controlled.

6. The system of claim 1 further comprising an on-board computer.

7. The system of claim 6 wherein the on-board computer includes one or more selected the group comprising of: an accelerometer, a magnetometer, a GPS, a gyroscope, a camera, a sensor, and a device information unit.

8. The system of claim 1 wherein the device further includes one or more selected from the group comprising of: an actuator and a weight.

9. The system of claim 7 wherein the sensor is positioned within the central manifold portion.

10. The system of claim 1 wherein the central manifold portion further includes a housing portion.

11. The system of claim 10 wherein an on-board computer is positioned within the housing portion.

12. The system of claim 7 wherein the device information unit includes information related to a number of nozzles, an angle between adjacent nozzles, and a direction of nozzles from one another.

13. The system of claim 1 further comprising an off-board computer.

14. The system of claim 13 wherein the off-board computer includes a Kinect sensor that detects depth data of a color.
